(19) United States
(12) Patent Application Publication
(10) Pub. No.: US 2010/0276904 A1
(43) Pub. Date: Nov. 4, 2010

(54) HIGH TRAVEL INDEPENDENT SUSPENSION WITH UPRIGHT

(76) Inventor: Gregory D. Pavuk, Royal Oak, MI (US)

Correspondence Address: CARLSON, GASKEY & OLDS, P.C., 400 WEST MAPLE ROAD, SUITE 350, BIRMINGHAM, MI, 48009, US

(21) Appl. No.: 12/377,870

(22) PCT Filed: Nov. 13, 2007
(86) PCT No.: PCT/US07/84473

§ 371 Date: Feb. 18, 2009

Related U.S. Application Data
(60) Provisional application No. 60/861,553, filed on Nov. 28, 2006.

(51) Int. Cl. B60G 3/20

(52) U.S. Cl. 280/124.135

(57) ABSTRACT

An independent suspension includes a knuckle with a spindle that supports a rotating wheel component. An upright includes upper and lower portions that are coupled to the knuckle such that the upright and knuckle are movable relative to each other. An upper control arm is connected to the upper portion of the upright, and a lower control arm is connected to the lower portion of the upright.

### RELATED APPLICATION

This application claims priority to U.S. Provisional Application No. 60/861,553, which was filed on Nov. 28, 2006.

### TECHNICAL FIELD

This invention generally relates to an independent suspension that utilizes an upright to increase wheel travel and steer angles.

### BACKGROUND OF THE INVENTION

Vehicle suspensions are utilized in many different types of applications, such as commercial over-the-road applications and military applications, for example. State of the art military suspensions are typically configured as independent suspension modules that are easy to service, have active ride height control, and have a larger amount of wheel travel to accommodate off-road conditions. Commercially available suspensions have a wheel travel limit that falls within a range of fourteen to eighteen inches, which is less than what is typically required for a military suspension.

One type of independent suspension utilized in a heavy-duty type of application is a short long arm (SLA) suspension that uses upper and lower control arms of unequal length. One SLA suspension unit is provided at each wheel of the vehicle. Typically, the upper control arm is shorter than the lower control arm to control camber changes during jounce and rebound occurrences. The upper and lower control arms are coupled to a knuckle with ball joints. The knuckle supports a rotating wheel hub. One driving half-shaft is used to drive each vehicle wheel. A centered double cardan joint couples the driving half-shaft to a rotating wheel component, which rotates the wheel hub supported on a spindle portion of the knuckle.

New target wheel travel ranges of up to twenty-four inches have been proposed to improve vehicle mobility, especially for military applications. This significant amount of wheel travel is difficult to achieve for two main reasons. First, the ball joints used to connect the upper and lower control arms to the knuckle are typically limited to 24 degrees of angular misalignment, which is the primary reason why current suspensions have less than twenty inches of travel.

The second reason concerns a maximum compound angle on the driving half-shaft, which is limited by rebound and full steer design restraints. In addition to increasing wheel travel, new target steer angles of over fifty degrees have been proposed. The centered double cardan joint, which couples the driving half-shaft to the rotating wheel component, can only articulate forty degrees. A constant velocity (CV) joint can only articulate forty-two degrees. Thus, with the proposed increases in wheel travel and steer angles, there is a need for a suspension that can accommodate larger steer angles, and which can provide greater wheel travel.

### SUMMARY OF THE INVENTION

An independent suspension includes a knuckle with a spindle that supports a rotating wheel component. An upright includes upper and lower portions that are coupled to the knuckle such that the upright and knuckle are movable relative to each other. An upper control arm connected to the upper portion of the upright, and a lower control arm is connected to the lower portion of the upright.

In one example, the upright includes an upper portion, a lower portion, and a vertical wall portion that connects the upper and lower portions. The upper portion of the upright is movably connected to an upper boss of the knuckle, and the lower portion of the upright is movably connected to a lower boss of the knuckle.

In one example, the upper and lower portions of the upright are connected to the knuckle with ball joints.

In one example, the upper and lower control arms are pivotally connected to the upright with pin connections.

In one example, a wheel drive shaft is coupled to the rotating wheel component with a non-centered double cardan joint. The non-centered double cardan joint includes a first shaft portion associated with the rotating wheel component and a second shaft portion associated with the wheel drive shaft. The vertical wall portion of the upright includes an opening that receives at least one bearing to support the second shaft portion.

In one example, the rotating wheel component defines an axis of rotation, and the upright defines a laterally extending center axis that spaced apart from the axis of rotation. The opening in the upright is offset from the laterally extending center axis in a direction toward the lower control arm.

In one example, the upright includes a spring platform to support a spring element. The spring platform extends in an inboard direction from the vertical wall portion of the upright.

In one example, the independent suspension includes a shock absorber that has a first end mounted to the lower control arm and a second end that is to be attached to a vehicle frame member.

The independent suspension is configured to accommodate larger steer angles and to provide greater wheel travel than prior designs. These and other features of the present invention can be best understood from the following specification and drawings, the following of which is a brief description.

### BRIEF DESCRIPTION OF THE DRAWINGS

FIG. 1 is a highly schematic representation of an independent suspension module for a pair of laterally spaced wheels.

FIG. 2 is a schematic side view of an independent suspension for one wheel.

### DETAILED DESCRIPTION OF THE PREFERRED EMBODIMENT

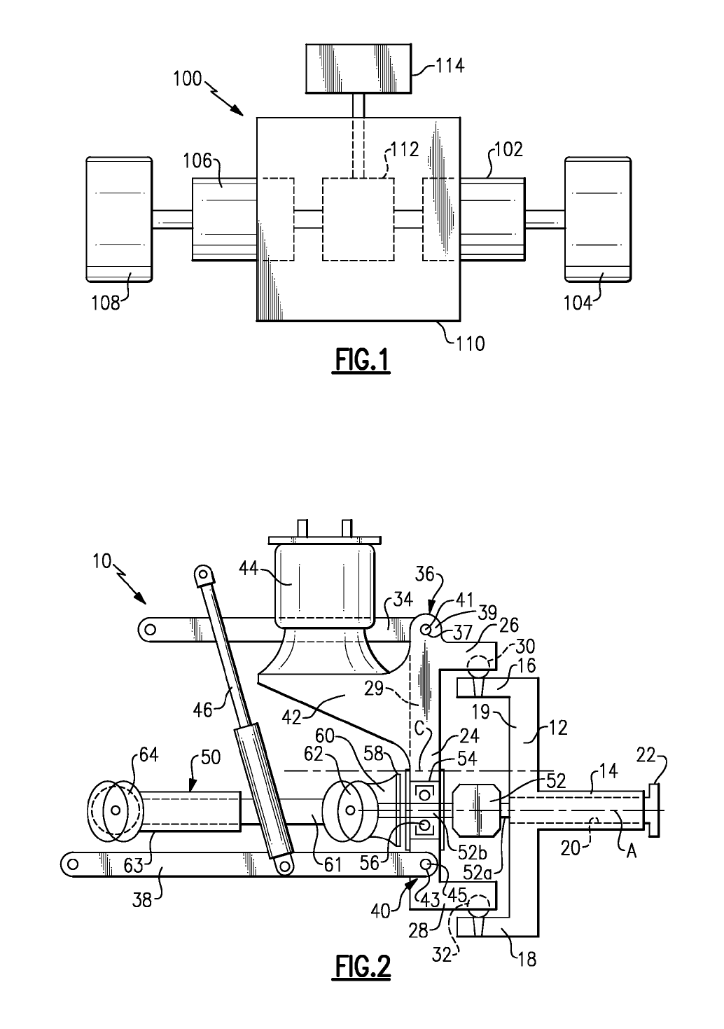

An independent suspension 100 is schematically shown at 100 in FIG. 1. The independent suspension 100 includes a first suspension unit 102 that is associated with a first wheel 104 and a second suspension unit 106 that is associated with a second wheel 108, which is laterally spaced from the first wheel 104. The first 102 and second 106 suspension units independently connect the first 104 and second 108 wheels to a frame 110 such that the first 104 and second 108 wheels can move independently of each other in response to load inputs. The frame 110 forms part of a vehicle structure as known.

A central drive source 112, such as a differential carrier for example, receives driving input from a power source 114 and provides driving output to the first 104 and second 108 wheels. The power source 114 can be an electric motor or engine, for example.

An example of the first suspension unit 102 is shown in FIG. 2. It should be understood that the second suspension unit 106 would be similarly configured. The first suspension unit 102 comprises an independent suspension for the wheel 104 (FIG. 1) and is sometimes referred to as a short long arm (SLA) suspension. The SLA suspension 10 includes a knuckle 12 with a spindle 14 that is adapted to rotatably support the wheel 104. The knuckle 12 includes an upper boss 16 and a lower boss 18, and a vertical body portion 19 that connects the upper 16 and lower 18 bosses.

The spindle 14 extends outwardly from the vertical body portion 19 in an outboard direction. The spindle 14 includes a center bore 20 that receives a rotating wheel component 22, such as a wheel shaft for example. The rotating wheel component 22 is coupled to a wheel structure to rotate the wheel 104 as known.

An upright 24 is coupled to the knuckle 12. The upright 24 has an upper portion 26, a lower portion 28, and a vertical wall portion 29 that connects the upper 26 and lower 28 portions. In one example, the upper portion 26 is coupled to the upper boss 16 of the knuckle 12 with a first ball joint 30, and the lower portion 28 is coupled to the lower boss 18 of the knuckle 12 with a second ball joint 32. The first 30 and second 32 ball joints allow relative articulation between the knuckle 12 and the upright 24. Optionally, pin joints or other types of joints could also be used.

An upper control arm 34 is connected to the upper portion 26 of the upright 24 with a first pin joint 36, and a lower control arm 38 is connected to the lower portion 28 of the upright 24 with a second pin joint 40. The first 36 and second 40 pin joints allow pivoting movement between the upper 34 and lower 38 control arms and the upright 24. Opposite ends of the upper 34 and lower 38 control arms are coupled to the frame 110 (FIG. 1) as known.

The first pin joint 36 comprises an aperture 37 that is formed within an upwardly extending boss 39 that extends vertically upward from the upper portion 26 of the upright 24. A pin body 41 is received within the aperture 37. The second pin joint 40 comprises an aperture 43 that is formed within the vertical wall portion 29 of the upright 24. The aperture 43 is positioned vertically above the lower portion 28 of the upright 24. A pin body 45 is received within the aperture 43. In another example, movable connections other than pin joints are used to connect the control arms to the upright.

A spring platform 42 is supported on the upright 24. In the example shown, the spring platform 42 is integrally formed with the upright 24 as a single piece component. The spring platform 42 supports a spring element 44, such as an air spring for example. An upper end of the spring element 44 is mounted to a vehicle structure, such as the frame 110, for example.

In one example, the spring platform 42 is formed as part of the vertical wall portion 29 of the upright. The spring platform 42 extends outwardly from the vertical wall portion 29 in an inboard direction.

An additional spring/shock element 46, such as a shock absorber for example, is utilized to further dampen road load inputs. One end of the shock element 46 is coupled to the lower control arm 38 and an opposite end is coupled to the frame 110.

A driving half-shaft 50, such as a slip-shaft for example, is coupled to the rotating wheel component 22 with a non-centered double cardan joint 52. The non-centered double cardan joint 52 is positioned laterally between the knuckle 12 and the upright 24. In the example shown, the vertical wall portion 29 of the upright 24 is positioned inboard of the non-centered double cardan joint 52, and the vertical body portion 19 of the knuckle 12 is positioned outboard of the non-centered double cardan joint 52. The non-centered double cardan joint 52 includes a first shaft portion 52a that is associated with the rotating wheel component 22 and a second shaft portion 52b that is coupled with the driving half-shaft 50.

The non-centered double cardan joint 52 can articulate up to fifty-five degrees. This type of joint is not traditionally used in drivelines because the lack of a centering mechanism in the joint causes an associated shaft to flop. This is not a problem with the present configuration because the vertical wall portion 29 of the upright 24 includes an opening 54 that receives a caged bearing 56. The structure of the upright 24 and the associated caged bearing 56 provide the needed support for the non-centered double cardan joint 52. In this configuration, the non-centered double cardan joint 52 would only be responsible for steering angles, which can be up to fifty-five degrees.

A single cardan half-shaft (not shown), or a double cardan half-shaft 60, is coupled to one end 61 of the driving half-shaft 50 depending upon the amount of articulation that is required. A flange 58 associated with the second shaft portion 52b of the non-centered double cardan joint 52 is coupled to the double cardan half-shaft 60. The double cardan half-shaft 60 is part of a first centered double cardan joint 62, which is located on the one end 61 of the driving half-shaft 50. A second centered double cardan joint 64 is coupled to an opposite end 63 of the driving half-shaft 50. The first 62 and second 64 centered double cardan joints are both located inboard of the vertical wall portion 29 of the upright 24. The second centered double cardan joint 64 is coupled to an output from the central drive source 112 (FIG. 1).

The half-shaft 50 and the centered double cardan joints 62, 64 are only responsible for handling angles induced from jounce and rebound. This eliminates the need for these joints to additionally accommodate the steering angle, as this is now handled by the non-centered double cardan joint 52.

The center bore 20 of the spindle 14 defines an axis of rotation A about which the rotating wheel component 22 rotates. The upright 24 defines a laterally extending center axis C that is generally parallel to and spaced apart from the axis of rotation A. The opening 54 in the upright 24 that receives the caged bearing 56 is offset vertically below the center axis C, i.e., the opening 54 is positioned closer to the lower control arm 38 than the upper control arm 34. The spring platform 42 is positioned vertically between the upper portion 26 of the upright 24 and the laterally extending center axis C.

In this configuration, due to the use of the upright 24, the lower control arm 38 need not terminate outboard on a king pin axis as occurred in a traditional location. This allows the lower control arm 38 to be raised as far as possible, which improves ground clearance.

Further, the use of the upright 24 separates axes of steering and control arm rotation. Thus, pivots for the SLA suspension 10 could be either ball joints or pin joints. Additionally, the proposed centered double cardan joints could be replaced with CV or Cornay joints depending on articulation requirements. Also, additional spring and damping elements could be attached directly to the upright 24 to provide a desirable 1:1 motion ratio to the wheel.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. An independent suspension comprising:
a knuckle including a spindle to support a rotating wheel component;
an upright coupled to said knuckle for relative motion thereto, said upright including an upper portion and a lower portion;
an upper control arm connected to said upper portion of said upright; and
a lower control arm connected to said lower portion of said upright.

2. The independent suspension according to claim 1 including a spring platform to support a spring element, said spring platform being supported by said upright.

3. The independent suspension according to claim 2 wherein said spring platform is integrally formed as one-piece with said upright.

4. The independent suspension according to claim 1 wherein said upper and said lower portions of said upright are connected to said knuckle with first and second movable connections, respectively.

5. The independent suspension according to claim 4 wherein said upper and said lower control arms are connected to said upright with third and fourth movable connections, respectively.

6. The independent suspension according to claim 5 wherein said first and said second movable connections each comprise a ball joint connection, and wherein said third and said fourth movable connections each comprise a pin joint connection.

7. The independent suspension according to claim 1 including a wheel drive shaft and a non-centered double cardan joint that couples said wheel drive shaft to the rotating wheel component.

8. The independent suspension according to claim 7 wherein said spindle defines an axis of rotation for the rotating wheel component and wherein said upright has a laterally extending center axis spaced apart from said axis of rotation, said upright including an opening through which said wheel drive shaft extends, said opening being offset from said laterally extending center axis.

9. The independent suspension according to claim 8 wherein said laterally extending center axis is generally parallel to said axis of rotation.

10. The independent suspension according to claim 8 including a bearing assembly received within said opening, said bearing assembly supporting a shaft portion of said non-centered double cardan joint.

11. The independent suspension according to claim 8 wherein said opening is offset in a direction toward said lower control arm.

12. The independent suspension according to claim 7 including a first centered double cardan joint coupled to one end of said wheel drive shaft and a second centered double cardan joint coupled to an opposite end of said wheel drive shaft, and wherein said non-centered double cardan joint couples one of said first and said second centered double cardan joints to the rotating wheel component.

13. The independent suspension according to claim 12 wherein said upright includes a vertical wall portion that connects said upper and said lower portions, and wherein said non-centered double cardan joint is laterally outboard of said vertical wall portion and said first and said second centered double cardan joints are laterally inboard of said vertical wall portion.

14. An independent suspension comprising:
a knuckle including an upper boss, a lower boss, a vertical body portion connecting said upper and said lower bosses, and a spindle extending outwardly from said vertical body portion in an outboard direction, said spindle including a center bore that receives a rotating wheel component;
an upright including an upper portion, a lower portion, and a vertical wall portion that connects said upper and said lower portions, said upper portion of said upright being coupled to said upper boss of said knuckle for relative motion thereto, and said lower portion of said upright being coupled to said lower boss of said knuckle for relative motion thereto;
an upper control arm pivotally connected to said upper portion of said upright; and
a lower control arm pivotally connected to said lower portion of said upright.

15. The independent suspension according to claim 14 including a wheel drive shaft coupled to said rotating wheel component with a non-centered double cardan joint.

16. The independent suspension according to claim 15 wherein said non-centered double cardan joint includes a first shaft portion associated with said rotating wheel component and a second shaft portion associated with said wheel drive shaft, and wherein said vertical wall portion of said upright includes an opening that receives at least one bearing to support said second shaft portion.

17. The independent suspension according to claim 16 wherein said rotating wheel component is rotatable about an axis of rotation, and wherein said upright defines a laterally extending center axis that is spaced apart from and generally parallel to said axis of rotation, said opening in said upright being offset from said laterally extending center axis in a direction toward said lower control arm.

18. The independent suspension according to claim 16 including a first centered double cardan joint coupled to one end of said wheel drive shaft that receives driving input and a second centered double cardan joint coupled to an opposite end of said wheel drive shaft, said second shaft portion of said non-centered double cardan joint being coupled to said second centered double cardan joint.

19. The independent suspension according to claim 14 including a spring platform to support a spring element, said spring platform supported by said vertical wall portion of said upright.

20. The independent suspension according to claim 14 including a shock absorber having a first end mounted to said lower control arm and a second end to be attached to a vehicle frame member.
